(19) United States
(12) Patent Application Publication
(10) Pub. No.: US 2026/0327409 A1
(43) Pub. Date: Oct. 22, 2026

(54) RESIN COMPOSITION FOR BOND MAGNET AND BOND MAGNET FORMED BODY FORMED USING SAME

(71) Applicant: TODA KOGYO CORP., Hiroshima (JP)

(72) Inventors: Hiromitsu SAKURAI, Hiroshima (JP); Makoto HINO, Hiroshima (JP); Nobuhiro KATAYAMA, Hiroshima (JP)

(21) Appl. No.: 19/105,967

(22) PCT Filed: Aug. 28, 2023
(86) PCT No.: PCT/JP2023/030855

§ 371 Date: Feb. 24, 2025

(30) Foreign Application Priority Data
Sep. 14, 2022 (JP) 2022-145938

(51) Int. Cl. C08K 9/06; C08G 69/26; H01F 1/06

(52) U.S. Cl. CPC C08K 9/06; C08G 69/26; H01F 1/06; C08K 2201/01

(57) ABSTRACT

An aspect of the present disclosure can provide: a resin composition for a bonded magnet, which is excellent in physical properties such as heat resistance, flexural strength, and IZOD impact strength without deteriorating magnetic characteristics and has a low water absorption rate; and a bonded magnet molded body molded using the resin composition. The resin composition for a bonded magnet includes at least a magnetic powder and a binder resin, in which the magnetic powder is contained in an amount of 70 wt % or more, and 5 to 30 wt % of a resin having a PA10 skeleton is contained as the binder resin.

### TECHNICAL FIELD

An aspect of the present disclosure relates to a resin composition for a bonded magnet, and a bonded magnet molded body molded using the resin composition.

### BACKGROUND ART

As is well known, a bonded magnet has advantages such as light weight, excellent dimensional accuracy, and easy mass production of products having complicated shapes as compared with a sintered magnet. Therefore, a bonded magnet is widely used in various applications such as toys, office equipment, acoustic equipment, and motors.

As magnetic powders used for a bonded magnet, rare earth magnet powder represented by an Nd—Fe—B-based magnetic powder, and ferrite particle powder are known. Rare earth magnet powder has high magnetic characteristics, but is expensive and limited in usable applications. On the other hand, ferrite particle powder is inferior to rare earth magnet powder in terms of magnetic characteristics, but is inexpensive and chemically stable. Therefore, ferrite particle powder is used in a wide range of applications.

A bonded magnet is generally produced by kneading rubber or a plastic material and a magnetic powder, and then molding them in a magnetic field or molding them by a mechanical method.

In recent years, with an increase in functionality including improvement in productivity and improvement in reliability at the time of use of various materials and devices, a bonded magnet to be used therefor has been required to have high performance such as improvements in productivity, mechanical strength, and magnetic characteristics.

For example, in a vehicle or the like, a bonded magnet is used as a rotor or a sensor. In this regard, there is a strong demand for high heat resistance and mechanical strength in order to prolong the life of the device and to use the device at high speed rotation. Therefore, a bonded magnet using a polyamide resin or a PPS resin as a binder resin is used. A polyamide resin and a PPS resin are considered to have high heat resistance and little decrease in mechanical physical properties at high temperatures.

For example, Patent Literature 1 proposes that polyamide 6 or polyamide 12 and a nonmagnetic powder are mixed at a predetermined ratio to produce a compound for a bonded magnet having high heat resistance and being excellent in mechanical strength and magnetic characteristics. Patent Literature 2 proposes that a compound for a bonded magnet having high heat resistance and being excellent in mechanical strength and magnetic characteristics is produced by adding modified polyolefins and glass fiber to a PPS resin.

Further, Patent Literature 3 proposes a resin composition for a bonded magnet which includes a phosphorus-based antioxidant in order to obtain a bonded magnet in which a decrease in strength is small even when exposed to a high-temperature environment.

### CITATION LIST

### Patent Literature

Patent Literature 1: JP-A-2005-72240
Patent Literature 2: JP-A-H4-44304
Patent Literature 3: JP-A-2015-76572

### SUMMARY OF INVENTION

### Problems to be Solved by Invention

However, a bonded magnet using polyamide 6, polyamide 12, or a PPS resin have concerns about heat resistance, dimensional accuracy, strength, and the like due to the influence of the resin-derived melting point, water absorption, strength, and the like. Therefore, a material having a high melting point, a low water absorption rate, and high strength is strongly required.

Therefore, one technical problem in the present disclosure is to obtain a resin composition for a bonded magnet, which is excellent in physical properties such as heat resistance, flexural strength, and IZOD impact strength and has a low water absorption rate without deteriorating magnetic characteristics, and a molded body molded using the resin composition.

### Solution to Problems

The technical problem can be achieved by the following aspects of the present disclosure.

That is, a resin composition for a bonded magnet according to an aspect of the present disclosure includes at least a magnetic powder and a binder resin, in which the magnetic powder is contained in an amount of 70 wt % or more, and 5 to 30 wt % of a resin having a PA10 skeleton is contained as the binder resin (first aspect).

In the resin composition for a bonded magnet of the first aspect, the resin having a PA10 skeleton may have a melting point of 200° C. or higher (second aspect).

The resin composition for a bonded magnet according to the first aspect or the second aspect may include 10 wt % or less of an inorganic reinforcing material (third aspect).

A bonded magnet molded body according to an aspect of the present disclosure is a bonded magnet molded body molded using the resin composition for a bonded magnet according to any one of the first to third aspects (fourth aspect).

### Effects of Invention

A molded body molded using the resin composition for a bonded magnet according to an aspect of the present disclosure has high physical properties such as flexural strength and IZOD impact strength without deteriorating Br (residual magnetic flux density), and has a small water absorption. Therefore, the molded body is suitable as a bonded magnet.

### DESCRIPTION OF EMBODIMENTS

Hereinafter, embodiments of the present disclosure will be described in detail.

The resin composition for a bonded magnet according to the present embodiment includes at least a magnetic powder and a binder resin.

The magnetic powder in the present embodiment is not particularly limited. As the magnetic powder, a magnetic powder used for a bonded magnet, for example, ferrite particle powder or rare earth magnetic powder can be usually used.

The ferrite particle powder is preferably a magnetoplumbite type ferrite particle powder. The magnetoplumbite type ferrite particle powder is represented by the formula AO·nFe₂O₃ (wherein A is Ba, Sr, or Ba—Sr, and n=5.0 to 6.5). Examples of the ferrite particle powder represented by this formula include a barium ferrite particle powder, a strontium ferrite particle powder, and a barium-strontium ferrite particle powder. These ferrite particle powders may contain, as constituent elements, 0.1 to 7.0 mol % of one or more elements selected from Ti, Mn, Al, La, Zn, Bi, and Co.

The average particle diameter of the ferrite particle powder is preferably 1.0 to 5.0 μm, and more preferably 1.0 to 2.0 μm. The BET specific surface area of the ferrite particle powder is preferably 1 to 10 m²/g, and more preferably 1 to 5 m²/g. The coercive force iHc of the ferrite particle powder is preferably 119 to 557 kA/m (1500 to 7000 Oe), and more preferably 119 to 398 kA/m (1500 to 5000 Oe). The residual magnetization of the ferrite particle powder is preferably 100 to 300 mT (1000 to 3000 G), and more preferably 100 to 200 mT (1000 to 2000 G).

The rare earth magnetic powder is an intermetallic compound containing at least one rare earth element and at least one transition metal in constituent elements. Examples of the rare earth magnetic powder include rare earth cobalt-based, rare earth-iron-boron-based, and rare earth-iron-nitrogen-based magnetic powders. In particular, when a rare earth-iron-boron-based magnetic powder or a rare earth-iron-nitrogen-based magnetic powder is used, a bonded magnet having excellent magnetic characteristics can be obtained.

The average particle diameter of the rare earth magnetic powder is preferably 1 to 120 μm, and more preferably 1 to 80 μm. The BET specific surface area of the rare earth magnetic powder is preferably 0.5 to 5 m²/g, and more preferably 0.5 to 3 m²/g. The coercive force iHc of the rare earth magnetic powder is preferably 239 to 1591 kA/m (3.0 to 20 kOe), and more preferably 318 to 1114 kA/m (4.0 to 15 kOe). The residual magnetization of the rare earth magnetic powder is preferably 0.3 to 1.8 mT (3.0 to 18 kG), and more preferably 0.5 to 1.3 mT (5.0 to 13 kG).

Note that the Nd—Fe—B-based magnetic powder may be used as it is for kneading. However, when the Nd—Fe—B-based magnetic powder is a flaky powder, it is desirable that the Nd—Fe—B-based magnetic powder is pulverized with a jet mill, an atomizer, a ball mill, or the like to have an average particle diameter of 100 μm or less in order to obtain higher fluidity and magnetic characteristics.

Examples of a soft ferrite particle powder include Mn—Zn ferrite, Ni—Zn ferrite, Ni—Zn—Cu ferrite, Mn—Mg ferrite, carbonyl iron powder, and sendust. Soft ferrite having a chemical composition changed according to the frequency of the electromagnetic wave to be used can also be used.

The average particle diameter of the soft ferrite powder is preferably 1 to 150 μm, and more preferably 1 to 50 μm.

These magnetic powders are desirably subjected to various surface treatments in order to suppress deterioration of magnetic characteristics due to oxidation, improve compatibility with the resin, and improve the strength of the molded body.

Examples of the material that can be used for the surface treatments include a silane-based coupling agent, a titanium-based coupling agent, an aluminum-based coupling agent, a siloxane polymer, an organic phosphoric acid-based surface treatment agent, and an inorganic phosphoric acid-based surface treatment agent. In particular, the strength of the molded body can be further improved by previously treating the surface of the magnetic powder with a silane-based coupling agent.

The content of the magnetic powder in the resin composition for a bonded magnet according to the present embodiment is 70 wt % or more. When the content of the magnetic powder is less than 70 wt %, it is difficult to obtain required magnetic characteristics. It is not preferable that the content of the magnetic powder exceeds 95 wt % because the mechanical strength of a resulting bonded magnet is reduced, and moldability such as fluidity and recyclability is reduced. The content of the magnetic powder is more preferably 75 to 93 wt %, and further preferably 77 to 91 wt %.

The binder resin in the present embodiment contains a resin having a PA10 skeleton as a main component. The resin having a PA10 skeleton refers to a bio-based polyamide synthesized mainly using sebacic acid derived from castor oil, such as PA410, PA610, and PA1010.

The resin composition for a bonded magnet according to the present embodiment contains 5 to 30 wt % of the resin having a PA10 skeleton as the binder resin. When the content of the resin having a PA10 skeleton is less than 5 wt %, sufficient fluidity of the resin composition for a bonded magnet cannot be obtained, and the mechanical strength of the bonded magnet decreases. Therefore, it is difficult to obtain a good molded body. When the content of the resin having a PA10 skeleton exceeds 30 wt %, magnetic characteristics deteriorate. The content of the resin having a PA10 skeleton is preferably 7 to 25 wt %, and more preferably 10 to 23 wt %.

The resin having a PA10 skeleton, which is used in the resin composition for a bonded magnet according to the present embodiment, has a low water absorption. Therefore, the molded body obtained by molding the resin has high dimensional stability.

The resin having a PA10 skeleton used in the resin composition for a bonded magnet according to the present embodiment has a relatively high melting point while having a long carbon chain. For example, the melting point of PA410 is 250° C., the melting point of PA610 is 225° C., and the melting point of PA1010 is 205° C. The resin having a melting point of 200° C. or higher is preferable because the molded body obtained using the resin composition for a bonded magnet has a high heat distortion temperature.

The resin having a PA10 skeleton to be used in the resin composition for a bonded magnet according to the present embodiment is not particularly limited. However, the average molecular weight of this resin is preferably 10,000 to 100,000. When a low-molecular-weight resin having a PA10 skeleton is used, the resin composition for a bonded magnet is excellent in moldability and poor in physical properties such as strength of a resulting molded body because the melt viscosity of the resin is low. On the other hand, when a high-molecular-weight resin having a PA10 skeleton is used, the resin composition for a bonded magnet is conversely excellent in strength of a resulting molded body, but is poor in moldability when the filling amount of the magnetic powder is increased because the viscosity of the resin is high.

In addition, the resin composition for a bonded magnet according to the present embodiment may contain, as the binder resin, a polyamide resin and/or various elastomers in addition to the resin having a PA10 skeleton as necessary within a range not impairing the characteristics of the resin composition for a bonded magnet of the present embodiment.

As the inorganic reinforcing material, glass fiber or the like can be used. The resin composition for a bonded magnet of the present embodiment can contain the inorganic reinforcing material within a range not impairing the characteristics of the resin composition. The content of the inorganic reinforcing material is preferably 10 wt % or less. The content of the inorganic reinforcing material is more preferably 1 to 8 wt %, and further preferably 2.1 to 7 wt %.

In the resin composition for a bonded magnet according to the present embodiment, the residual magnetic flux density Br when the ferrite particle powder is used as the magnetic powder is preferably 170 mT (1700 G) or more, and more preferably 175 mT (1750 G) or more. The coercive force iHc of the resin composition for a bonded magnet is preferably 119 to 279 kA/m (1500 to 3500 Oe), and more preferably 127 to 259 kA/m (1600 to 3250 Oe). The maximum energy product (BH)max of the resin composition for a bonded magnet is preferably 5.5 kJ/m³ (0.70 MGOe) or more, and more preferably 10.7 kJ/m³ (1.35 MGOe) or more. The values of the residual magnetic flux density Br, the coercive force iHc. and the maximum energy product (BH)max are values measured for the molded body by a magnetism measurement method described later.

In the resin composition for a bonded magnet according to the present embodiment, the residual magnetic flux density Br when the rare earth magnetic powder is used as the magnetic powder is preferably 300 mT (3000 G) or more, and more preferably 350 mT (3500 G) or more. The coercive force iHc of the resin composition for a bonded magnet is preferably 636 to 955 kA/m (8000 to 12000 Oe), and more preferably 676 to 915 kA/m (8500 to 11500 Oe). The maximum energy product (BH)max of the resin composition for a bonded magnet is preferably 15.9 kJ/m³ (2.00 MGOe) or more, and more preferably 19.9 kJ/m³ (2.50 MGOe) or more. The values of the residual magnetic flux density Br, the coercive force iHc, and the maximum energy product (BH)max are values measured for the molded body by a magnetism measurement method described later.

The flexural strength of the molded body molded using the resin composition for a bonded magnet according to the present embodiment is desirably 110 MPa or more. When the flexural strength is less than 110 MPa, the mechanical strength of the molded body is low, so that cracks (cracking) of the molded body are likely to occur.

The IZOD impact strength of the molded body molded using the resin composition for a bonded magnet according to the present embodiment is desirably 10 kJ/m² or more. When the IZOD impact strength is less than 10 kJ/m², the mechanical strength of the molded body is low, so that cracks (cracking) of the molded body are likely to occur.

The deflection temperature under load of the molded body molded using the resin composition for a bonded magnet according to the present embodiment is preferably 140° C. or higher. When the deflection temperature under load is lower than 140° C., the molded body may be deformed in a high-temperature environment.

The water absorption rate of the molded body molded using the resin composition for a bonded magnet according to the present embodiment is desirably 1.0 wt % or less. When the water absorption rate exceeds 1.0 wt %, the molded body swells, and dimensional change and/or cracks (cracking) may occur in the molded body.

Next, a method for producing the resin composition for a bonded magnet according to the present embodiment will be described.

The resin composition for a bonded magnet according to the present embodiment can be obtained by a known method for producing a resin composition for a bonded magnet. The resin composition for a bonded magnet is obtained, for example, by uniformly mixing a magnetic powder and a resin component having a PA10 skeleton, then melt-kneading the mixture using a kneading extruder or the like, and pulverizing or cutting the kneaded product into particles or pellets.

The resin composition for a bonded magnet according to the present embodiment can optionally contain a lubricant for plastic molding, various stabilizers, and the like in order to obtain effects such as improvement in moldability, improvement in heat resistance, prevention of oxidation degradation, and rust prevention.

Examples of the lubricant to be used include carboxyl saturated/unsaturated fatty acid-based substances such as propionic acid, stearic acid, linoleic acid, oleic acid, malonic acid, glutaric acid, adipic acid, maleic acid, and fumaric acid, and compounds of these substances. Examples of the compounds of these substances include metal soaps such as calcium stearate, magnesium stearate, and lithium stearate, fatty acid amides such as hydroxydistearamide, ethylene-bis-laurylamide, and ethylene-bis-oleamide, waxes such as paraffin wax, polysiloxanes such as dimethylpolysiloxane and silicon oil, and fluorine compounds such as fluorine-containing oil.

As the stabilizer, an antioxidant is preferably added in order to prevent deterioration due to heat. As the antioxidant, for example, a metal deactivator and a stabilizer can be used. Examples of the metal deactivator include N, N′-bis[3-(3,5-di-t-butyl-4-hydroxyphenyl)propionylhydrazine]. Examples of the stabilizers include a hindered amine-based stabilizer, a hindered/less-hindered phenol-based stabilizer such as pentaerythrityl-tetrakis[3-(3,5-di-t-butyl-4-hydroxyphenyl)propionate], a phosphite-based stabilizer, and a thioether-based stabilizer. In particular, it is effective to use a hindered/less-hindered phenol-based stabilizer in combination with a phosphite-based stabilizer or a metal deactivator.

The content of the antioxidant with respect to the total amount of the resin composition is preferably in a range of 0.1 to 1.0 wt %, and more preferably in a range of 0.2 to 0.8 wt %.

Further, a known mold release agent such as zinc stearate or calcium stearate can be added to the resin as necessary.

A molding method for obtaining a molded body molded using the resin composition for a bonded magnet of the present embodiment is not particularly limited. As this molding method, a known method can be used alone, or a plurality of known methods can be used in combination, as appropriate, depending on the material properties, molding purpose, application, and the like of the resin composition for a bonded magnet. Examples of the known method include a transfer method, an injection method, an extrusion method, an inflation method, a calendering method, a T-die method, a blowing method, a vacuum method, a lamination method, a spray-up method, a firing method, a matched die method, and an SMC method. In particular, in the resin composition for a bonded magnet using a thermoplastic resin, it is preferable to use an injection method or an extrusion method. These methods are methods which have been applied to many industrial components. According to these methods, mass production can be performed continuously and at a high speed.

### EXAMPLES

Hereinafter, representative examples of the present embodiment will be described. However, the present embodiment is not limited to these examples.

The average particle diameter of the ferrite particle powder used in the present example was measured using a “Sub-Sieve Sizer Model 95” (manufactured by Fisher Scientific).

The BET specific surface area of the ferrite particle powder used in the present example was measured using a “full automatic specific surface area meter Macsorb model-1201” (manufactured by Mountech Co., Ltd.).

The molding density of the molded body molded using the resin composition for a bonded magnet was determined as follows. First, the resin composition for a bonded magnet was melted in a mold having a diameter of 25 mm and a height of 10.5 mm to form a core. The core was measured using an “electronic densimeter EW-120 SG” (manufactured by YASUDA SEIKI SEISAKUSHO, LTD.) to determine the molding density of the molded body.

The melt mass flow rate (MFR) of the resin composition for a bonded magnet was determined in accordance with JIS K7210 as follows. The resin having a PA10 skeleton was melted at 270° C. and 300° C. The resin composition for a bonded magnet using a PA12 resin or a PA6 resin was melted at 270° C. The resin composition for a bonded magnet using a PPS resin was melted at 330° C. These were measured under a load of 10 kg to determine the melt mass flow rate (MFR) of the resin composition for a bonded magnet.

The magnetic characteristics (residual magnetic flux density Br, coercive force iHc, coercive force bHc, and maximum energy product (BH)max) of the resin composition for a bonded magnet were determined as follows.

First, using an injection molding machine J55AD type manufactured by The Japan Steel Works, Ltd., the resin composition for a bonded magnet in a molten state was molded in a mold having a diameter of 25 mm and a height of 10.5 mm while being magnetically oriented at 716.2 kA/m (9 kOe). Thereafter, the molded body was measured in a magnetic field of 1114.1 kA/m (14 kOe) using a “DC magnetization characteristic automatic recorder 3257” (manufactured by Yokogawa Hokushin Denki Co., Ltd.) to determine the above-described magnetic characteristics.

The flexural strength and IZOD impact strength of the molded body molded using the resin composition for a bonded magnet were determined in accordance with ASTM D790 and D256 standards. A test piece molded body was obtained using an injection molding machine J55AD type manufactured by The Japan Steel Works, Ltd. Thereafter, the flexural strength and IZOD impact strength of the test piece molded body were determined by measurement using a computer measurement control-type precision universal tester AG-1 type manufactured by Shimadzu Corporation and a NO. 158 manufactured by YASUDA SEIKI SEISAKUSHO, LTD.

The water absorption rate of the molded body molded using the resin composition for a bonded magnet was determined as follows. First, a test piece molded body was obtained using an injection molding machine J55AD type manufactured by The Japan Steel Works, Ltd. Thereafter, the test piece molded body was exposed for 100 hours in an 85° C./90% RH environment using a constant-temperature and constant-humidity tester LHL-113 manufactured by ESPEC Corp. Next, the weight of the molded body was measured before exposure and after exposure. Using these weights, the water absorption rate of the molded body was calculated by the following formula:

((weight after exposure−weight before exposure)/weight before exposure)×100 [wt %]

The deflection temperature under load of the molded body molded using the resin composition for a bonded magnet was determined in accordance with the ASTM D648 standard as follows. A test piece molded body having a total length of 127 mm, a total width of 13 mm, and a thickness of 3.2 mm was obtained using an injection molding machine J55AD type manufactured by The Japan Steel Works, Ltd. Thereafter, the test piece molded body was measured (test direction: edgewise, test stress: 1.82 MPA) using an HDT tester 3M-2V manufactured by Toyo Seiki Seisaku-sho, Ltd. to determine the deflection temperature under load of the molded body.

### Example 1

To 75.00 parts by weight of ferrite particle powder (average particle diameter: 1.20 n. BET value: 1.75 m²/g, coercive force: 226 kA/m (2850 Oe), saturation magnetization: 822 Am²/kg (72 emu/g)), 0.50 part by weight of an aminoalkyl-based silane coupling agent was added, and warm mixing was performed at 100° C. until the mixture became uniform. Thus, a surface-treated ferrite particle powder was obtained. The surface-treated ferrite particle powder, 24.29 parts by weight of a PA410 resin, and 0.21 part by weight of an antioxidant were sufficiently mixed with a Henschel mixer. The melting point of a PA410 resin is 250° C.

The obtained mixture was quantitatively fed to a twin-screw kneader and kneaded at 270° C. Further, the kneaded product was taken out into a strand shape and cut into pellets having a size of 2 mm in diameter×3 mm. Thus, a resin composition for a bonded magnet was obtained.

The chemical composition of the obtained resin composition for a bonded magnet is shown in Table 1. The molding density, MFR, and magnetic characteristics of the resin composition for a bonded magnet according to each Example are shown in Table 2.

The measurement results of the flexural strength, IZOD impact strength, deflection temperature under load, and water absorption rate of the test piece molded body obtained by injection molding the resin composition for a bonded magnet according to each Example are shown in Table 3.

TABLE 1

| | | | Exam- | Exam- | Exam- | Exam- | Exam- | Exam- | Exam- | Exam- | Exam- | Exam- | Exam- |
|---|---|---|---|---|---|---|---|---|---|---|---|---|---|
| Item | | Unit | ple 1 | ple 2 | ple 3 | ple 4 | ple 5 | ple 6 | ple 7 | ple 8 | ple 9 | ple 10 | ple 11 |
| Ferrite particle powder | | Parts by | 75.00 | 75.00 | 83.00 | 85.00 | 88..0 | 88..0 | 75.00 | 75.00 | 83.00 | 88.00 | 88.00 |
| | | weight | | | | | | | | | | | |
| Silane coupling agent | | Parts by | 0.50 | 0.50 | 0.50 | 0.50 | 0.50 | 0.50 | 0.50 | 0.50 | 0.50 | 0.50 | 0.50 |
| | | weight | | | | | | | | | | | |
| Binder resin | PA410 | Parts by | 24.29 | 21.87 | 11.39 | 14.29 | 11.29 | 9.29 | — | — | — | — | — |
| | | weight | | | | | | | | | | | |
| | PA610 | Parts by | — | — | — | — | — | — | 24.29 | 21.87 | 15.29 | 11.29 | 9.29 |
| | | weight | | | | | | | | | | | |

| Glass fiber | Parts by | — | 2.42 | 4.9 | — | — | 2.00 | — | 2.42 | 1.00 | — | 2.00 |
|---|---|---|---|---|---|---|---|---|---|---|---|---|
| | weight | | | | | | | | | | | |
| Antioxidant | Parts by | 0.21 | 0.21 | 0.21 | 0.21 | 0.21 | 0.21 | 0.21 | 0.21 | 0.21 | 0.21 | 0.21 |
| | weight | | | | | | | | | | | |

| | | | Exam- | Exam- | Exam- | Exam- | Exam- | Exam- | Exam- | Exam- | Exam- | Exam- | Exam- |
|---|---|---|---|---|---|---|---|---|---|---|---|---|---|
| Item | | Unit | ple 1 | ple 2 | ple 3 | ple 4 | ple 5 | ple 6 | ple 7 | ple 8 | ple 9 | ple 10 | ple 11 |
| Molding density | | g/cm³ | 2.72 | 2.83 | 3.43 | 3.33 | 3.68 | 3.76 | 2.65 | 2.77 | 3.02 | 3.57 | 3.69 |
| MFR (270 °C-10 kg) | | g/10 min | 123 | 84 | 22 | 44 | 25 | 10 | 162 | 99 | 58 | 30 | 15 |
| MFR (300 °C-10 kg) | | g/10 min | 286 | 161 | 39 | 74 | 45 | 20 | 339 | 186 | 130 | 50 | 25 |
| Magnetic | Br | G | 1780 | 1870 | 2190 | 2430 | 2780 | 2820 | 1690 | 1790 | 2100 | 2720 | 2710 |
| characteristics | | mT | 178 | 187 | 219 | 243 | 278 | 282 | 169 | 179 | 210 | 272 | 271 |
| | bHc | Oe | 1740 | 1820 | 1930 | 2180 | 2320 | 2120 | 1670 | 1750 | 2010 | 2330 | 2240 |
| | | kA/m | 138 | 144 | 153 | 173 | 184 | 168 | 132 | 139 | 159 | 185 | 178 |
| | iHc | Oe | 3300 | 3240 | 2720 | 2980 | 2810 | 2480 | 3420 | 3370 | 3260 | 2900 | 2750 |
| | | kA/m | 262 | 257 | 216 | 237 | 223 | 197 | 272 | 268 | 259 | 230 | 218 |
| | BHmax | MGOe | 0.80 | 0.88 | 1.16 | 1.46 | 1.94 | 1.96 | 0.72 | 0.81 | 1.11 | 1.85 | 1.83 |
| | | kJ/m³ | 6.3 | 7.0 | 9.2 | 11.6 | 15.4 | 15.5 | 5.7 | 6.4 | 8.8 | 14.7 | 14.5 |

TABLE 3

| | | Exam- | Exam- | Exam- | Exam- | Exam- | Exam- | Exam- | Exam- | Exam- | Exam- | Exam- |
|---|---|---|---|---|---|---|---|---|---|---|---|---|
| Item | Unit | ple 1 | ple 2 | ple 3 | ple 4 | ple 5 | ple 6 | ple 7 | ple 8 | ple 9 | ple 10 | ple 11 |
| Bending strength | MPa | 161 | 179 | 190 | 169 | 155 | 140 | 146 | 165 | 170 | 149 | 145 |
| IZOD impact strength (no notches) | kJ/m² | N.B. | N.B. | 20.4 | 23.4 | 16.0 | 12.0 | N.B. | N.B. | N.B. | 18.0 | 15.0 |
| Deflection temperature under load | °C | 176 | 192 | 217 | 186 | 193 | 213 | 160 | 179 | 197 | 180 | 200 |
| Water absorption rate | wt % | 0.6 | 0.6 | 0.45 | 0.50 | 0.41 | 0.37 | 0.55 | 0.5 | 0.4 | 0.33 | 0.29 |

*N.B.: Non break

### Examples 2 to 6

A resin composition for a bonded magnet was produced in the same manner as in Example 1 except that the formulations of the ferrite particle powder, the silane coupling agent, the PA410 resin, the glass fiber, and the antioxidant were variously changed as shown in Table 1.

### Examples 7 to 11

A resin composition for a bonded magnet was produced in the same manner as in Example 1 except that a PA610 resin was used as the binder resin, and that the formulations of the ferrite particle powder, the silane coupling agent, the PA610 resin, the glass fiber, and the antioxidant were variously changed as shown in Table 1. The melting point of the PA610 resin is 225° C.

### Comparative Examples 1 and 2

A resin composition for a bonded magnet was produced in the same manner as in Example 1 except that a PA12 resin was used as the binder resin, and that the formulations of the ferrite particle powder, the silane coupling agent, the PA12 resin, the glass fiber, and the antioxidant were variously changed as shown in Table 4. The melting point of the PA12 resin is 176° C.

The molding density. MFR, and magnetic characteristics of the obtained resin composition for a bonded magnet of each of Comparative Examples are shown in Table 5.

Table 6 illustrates the measurement results of the flexural strength, IZOD impact strength, deflection temperature under load, and water absorption rate of a test piece molded body obtained by injection molding the resin composition for a bonded magnet of each of Comparative Examples.

### Comparative Examples 3 and 4

A resin composition for a bonded magnet was produced in the same manner as in Example 1 except that a PA6 resin was used as the binder resin, and that the formulations of the ferrite particle powder, the silane coupling agent, the PA6 resin, and the antioxidant were variously changed as shown in Table 4. The melting point of the PA6 resin is 225° C.

### Comparative Examples 5 and 6

A resin composition for a bonded magnet was produced in the same manner as in Example 1 except that a PPS resin was used as the binder resin, and that the formulations of the ferrite particle powder, the silane coupling agent, the PPS resin, and the antioxidant were variously changed as shown in Table 4. The melting point of the PPS resin is 280° C.

TABLE 4

| | | | Comparative | Comparative | Comparative | Comparative | Comparative | Comparative |
|---|---|---|---|---|---|---|---|---|
| Item | | Unit | Example 1 | Example 2 | Example 3 | Example 4 | Example 5 | Example 6 |
| Ferrite particle powder | | Parts by weight | 80.00 | 88.00 | 84.10 | 88.00 | 82.27 | 84.40 |
| Silane coupling agent | | Parts by weight | 0.50 | 0.50 | 0.50 | 0.50 | 0.50 | 0.50 |
| Binder resin | PA12 | Parts by weight | 18.29 | 11.29 | — | — | — | — |
| | PA6 | Parts by weight | — | — | 15.19 | 11.29 | — | — |
| | PPS | Parts by weight | — | — | — | — | 17.02 | 14.89 |
| Glass fiber | | Parts by weight | 1.00 | — | — | — | — | — |
| Antioxidant | | Parts by weight | 0.21 | 0.21 | 0.21 | 0.2 | 0.21 | 0.21 |

TABLE 5

| | | | Comparative | Comparative | Comparative | Comparative | Comparative | Comparative |
|---|---|---|---|---|---|---|---|---|
| Item | | Unit | Example 1 | Example 2 | Example 3 | Example 4 | Example 5 | Example 6 |
| Molding density | | g/cm³ | 3.00 | 3.55 | 3.26 | 3.59 | 3.42 | 3.57 |
| MFR (270 °C-10 kg) | | g/10 min | 55 | 45 | 36 | 25 | — | — |
| MFR (330 °C-10 kg) | | g/10 min | — | — | — | — | 145 | 207 |
| Magnetic | Br | G | 2070 | 2750 | 2410 | 2750 | 2480 | 2640 |
| characteristics | | mT | 207 | 275 | 241 | 275 | 248 | 264 |
| | bHc | Oe | 2100 | 2300 | 2310 | 2290 | 2180 | 2240 |
| | | kA/m | 167 | 183 | 183 | 182 | 173 | 178 |
| | iHc | Oe | 2990 | 2980 | 3030 | 2970 | 2940 | 2860 |
| | | kA/m | 237 | 237 | 241 | 236 | 233 | 227 |
| | BHmax | MGOe | 1.05 | 1.86 | 1.45 | 1.86 | 1.49 | 1.72 |
| | | kJ/m³ | 8.3 | 14.8 | 11.5 | 14.8 | 11.8 | 13.6 |

TABLE 6

| | | Comparative | Comparative | Comparative | Comparative | Comparative | Comparative |
|---|---|---|---|---|---|---|---|
| Item | Unit | Example 1 | Example 2 | Example 3 | Example 4 | Example 5 | Example 6 |
| Bending strength | MPa | 130 | 128 | 191 | 188 | 104 | 106 |
| IZOD impact strength (no notches) | kJ/m² | N.B. | 21.6 | N.B. | 20.7 | 8.4 | 7.6 |
| Deflection temperature under load | °C | 135 | 136 | 163 | 176 | 210 | 219 |
| Water absorption rate | wt % | 0.30 | 0.20 | 1.30 | 1.10 | 0.05 | 0.04 |

*N.B.: Non break

It was confirmed that the resin compositions for a bonded magnet according to Examples had excellent characteristics regarding a deflection temperature under load as compared with the resin compositions for a bonded magnet of Comparative Examples 1 and 2 containing a PA12 resin. It was also confirmed that the resin compositions for a bonded magnet according to Examples had excellent characteristics regarding a water absorption ratio as compared with the resin compositions for a bonded magnet of Comparative Examples 3 and 4 containing a PA6 resin. It is to be noted that the resin compositions for a bonded magnet according to Examples were confirmed to have excellent characteristics regarding flexural strength and IZOD impact strength as compared with the resin compositions for a bonded magnet of Comparative Examples 5 and 6 containing a PPS resin.

### INDUSTRIAL APPLICABILITY

Therefore, when the resin composition for a bonded magnet according to the present embodiment is used, a molded body having high magnetic force properties, physical properties, and deflection temperature under load as well as a reduced water absorption rate can be obtained. Therefore, the resin composition for a bonded magnet according to the present embodiment can be suitably used as a material for a bonded magnet.

1. A resin composition for a bonded magnet comprising at least a magnetic powder and a binder resin, wherein
the magnetic powder is contained in an amount of 70 wt % or more, and
5 to 30 wt % of a resin having a PA10 skeleton is contained as the binder resin.

2. The resin composition for a bonded magnet according to claim 1, wherein the resin having a PA10 skeleton has a melting point of 200° C. or higher.

3. The resin composition for a bonded magnet according to claim 1, comprising 10 wt % or less of an inorganic reinforcing material.

4. A bonded magnet molded body molded using the resin composition for a bonded magnet according to claim 1.
